(19) United States
(12) Patent Application Publication
(10) Pub. No.: US 2008/0135572 A1
(43) Pub. Date: Jun. 12, 2008

(54) Apparatus for dispensing wipes

(76) Inventors: Jonathan Paul Brennan, Sharonville, OH (US); Michael Sean Pratt, St. Bernard, OH (US); Judson Leroy Haynes, Fairfield Township, OH (US)

Correspondence Address: THE PROCTER & GAMBLE COMPANY;INTELLECTUAL PROPERTY DIVISION - WEST BLDG., WINTON HILL BUSINESS CENTER - BOX 412, 6250 CENTER HILL AVENUE, CINCINNATI, OH, 45224, US

(21) Appl. No.: 11/982,583

(22) Filed: Nov. 2, 2007

Related U.S. Application Data
(60) Provisional application No. 60/856,145, filed on Nov. 2, 2006.

(51) Int. Cl. A47K 10/18; G09F 3/00

(52) U.S. Cl. 221/48; 221/47; 40/312

(57) ABSTRACT

A plurality of textured wipes is stored in a dispenser having an orifice in a configuration such that when a wipe is pulled through the orifice, a dispensing force is applied to the wipe. The dispensing force is chosen such that the wipes increase in thickness from about 15% to about 200% during dispensing without losing their structural integrity such as via ripping, tearing, delaminating and the like. During dispensing, a visual signal of the thickening of a wipe is provided.

### CROSS REFERENCE TO RELATED APPLICATIONS

This application claims the benefit of U.S. Provisional Application 60/856,145, filed Nov. 2, 2006.

### FIELD OF THE INVENTION

The present disclosure relates to wipes and in some embodiments “wet wipes,” which are stored in a dispenser having an orifice. A wipe is dispensed through the orifice by exerting a pulling force on the wipe. During dispensing, at least a portion of the wipe thickens. The present disclosure further relates to a method of signaling the thickness of a wet wipe during dispensing.

### BACKGROUND OF THE INVENTION

Many consumers of disposable pre-moistened nonwoven wipes, particularly baby wipes, desire a soft, cloth-like wipe that is economical. It is believed that consumers react to visual and tactile properties in their assessment of wipes. Thus, thickness and texture may signal to a consumer that a wipe has the properties of cloth.

To provide consumers with value and/or the convenience of disposability, wipes are typically made from low cost materials, such as nonwoven webs, plastic sheets, films, layers of pulp and the like. While these materials may provide for adequate cleaning of surfaces, they may fall short in providing the soft, cloth-like cleaning experience desired by at least some consumers.

Various approaches have been utilized to provide softer, more cloth-like wipes. One non-limiting approach has been to increase the thickness of wipes. Unfortunately, compressive forces encountered by wipes under typical storage and/or shipment conditions may reduce the thickness of the wipes. This can be especially problematic for wipes that are stored in a pre-moistened state, i.e., “wet wipes”.

Accordingly, it would be desirable to provide a means of recovering at least a portion of the thickness that can be lost during the storage and/or shipment of wipes, particularly wet wipes.

It would also be desirable to provide a means of signaling to a consumer that wipes, particularly wet wipes, have the cloth-like properties of thickness and/or texture.

### SUMMARY OF THE INVENTION

In at least one embodiment, there is provided an apparatus for dispensing wipes. The apparatus includes a dispenser. The dispenser includes an interior storage space for storing a plurality of wipes and an orifice for providing access to wipes stored in the interior storage space. The apparatus also includes a plurality of wipes disposed in the interior storage space of the dispenser. Each wipe disposed in the interior storage space has (i) an x,y plane; (ii) an activation force; and (iii) a thickness. When at least one of the wipes is removed from the interior storage space by pulling at least a portion of the wipe through the orifice with a dispensing force that is greater than the activation force, at least a portion of the wipe increases in thickness from 20% to 200%.

These and other embodiments, aspects, and advantages are encompassed within the present invention, and will become better understood with regard to the following description and appended claims.

### BRIEF DESCRIPTION OF THE DRAWINGS

The accompanying figures show non-limiting embodiments incorporating various aspects of the present invention.

FIG. 1 is a schematic view of one embodiment of a wipes stack configuration according to the present disclosure.

FIG. 2 is a schematic cross-sectional view of one embodiment of a wipe made from a composite according to the present disclosure.

FIG. 3 is a schematic cross-sectional view of the first and second regions of one embodiment of a wipe according to the present disclosure.

FIG. 4 is a schematic cross-sectional view of the first and second regions of one embodiment of a wipe according to the present disclosure during dispensing.

FIG. 5 is schematic cross-section view of one embodiment of a wipe disclosed herein.

FIGS. 6 and 7 are plan views of wipe embodiments having first and second regions according to the present disclosure.

FIG. 8 is a plan view of a wipes embodiment having first and second regions according to the present disclosure.

FIGS. 9 and 10 show a perspective view of a wipe embodiment according to the present disclosure having second regions comprising tufts and/or loops.

FIG. 11 shows photographs of an embodiment of a wipe according to the present disclosure and comparative wipes in both relaxed and strained states.

FIG. 12 shows profilometery for each of side of one of the present wipe embodiments and for comparative wipes, in both a relaxed state and strained state.

FIG. 13 shows a plot of the thickness vs. strain for an embodiment of the present wipe and for a comparative wipe.

FIG. 14 shows a plot of the increase in thickness vs. strain for an embodiment of the present wipe and for a comparative wipe.

FIG. 15 is a plot of force vs. strain for an embodiment of the present wipe and for a comparative wipe.

### DETAILED DESCRIPTION OF THE INVENTION

A “Wipe” as used herein, refers to a cleaning article that comprises a substrate of one or more layers of nonwoven web.

The terms “nonwoven web” or “web” are used interchangeably herein, and refer to a layer of individual fibers or threads that are interlaid, but not in an identifiable manner as in a knitted or woven web. Nonwoven webs may be made via processes known in the art, including but not limited to: carding; airlaying; and wetlaying. Processes comprising filament spinning from resin and integrated webforming include, but are not limited to: spunbonding; meltblowing; coforming; and forming spunbond-meltblown-spunbond composites. Fiber bonding processes of use may include, but are not limited to: spunlacing (i.e., hydroentanglement); cold calendering; hot calendering; air thru bonding; chemical bonding; needle punching; and combinations thereof.

“Fiber” as used herein, refers to the unit which forms the basic element of the nonwoven web disclosed herein. Fibers include staple fibers, fibers longer than staple fibers that are not continuous, and continuous fibers, which are sometimes referred to in the art as “substantially continuous filaments” or simply “filaments”. The method in which the fiber is prepared will determine if the fiber is a staple fiber or a continuous filament.

“Composite” as used herein, refers to superimposed layers of nonwoven web that are bonded together to form a wipe. Layers of material(s), such as pulp for example, may be interposed between the layers of nonwoven web and may be bonded together with the layers of nonwoven web to form a wipe. Bonding methods of use include, but are not limited to: spunlacing (hydroentanglement); hydroforming; and combinations thereof. Without wishing to be bound by theory, bonding steps of use in the present disclosure cause the fibers of the different layers of the composite to intertwine with one another. It is believed that the intertwining of the fibers between the layers holds the layers together such that the layers are no longer distinct and will not delaminate when pulled apart. This is in contrast to a laminate that is separable into the base layers from which it is comprised.

“Planar” as used herein refers to being in a single geometric plane, such as a plane defined by x and y axes, i.e., an “x,y plane”. In contrast, “non-planar” refers to being in more than one single geometric plane. For example, something which is three dimensional, i.e., has length, width, and height, or x, y and z axes, is non-planar.

“Protruding” as used herein, refers to extending out of a plane.

“Pre-moistened” and “wet” are used interchangeably herein and refer to wipes which are moistened with a liquid composition. The wipes may be moistened prior to packaging in a generally moisture impervious container or wrapper. Alternatively, the wipes can be sold dry and a liquid composition may be subsequently added thereto. The wipes, which can also be referred to as “wet wipes” and “towelettes,” may be suitable for use in cleaning hard surfaces, or for personal cleansing of babies, as well as older children and adults.

“Liquid composition” refers to any liquid, including, but not limited to: a pure liquid such as water, an aqueous solution, a colloid, an emulsion, a suspension, a lotion, a solution and mixtures thereof. The term “aqueous solution” as used herein, refers to a solution that is at least 20%, 40%, or even at least 50% water by weight, and is no more than 95%, or no more than 90% water by weight.

“Saturation loading” and “lotion loading” are used interchangeably herein and refer to the amount of liquid composition applied to the wipe. In general, the amount of liquid composition applied may be chosen in order to provide maximum benefits to the end product comprised by the wipe. Saturation loading is typically expressed as grams of liquid composition per gram of dry wipe and is measured using the method described below.

“Surface tension” as used herein, refers to the force at the interface between a liquid composition and air. Surface tension is typically expressed in dynes per centimeter (dynes/cm).

“Visible” as used herein refers to being visually detectable by a person with 20/20 vision when viewed at a distance of 30.48 centimeters (cm), under the unimpeded light of an ordinary incandescent 60 watt light bulb. “Visibly distinct” as used herein refers to the existence of a visible difference between items or areas of items that are compared to each other.

“Activation force” as used herein, refers to the force required to cause a portion of a substrate as described herein to protrude out of the plane of the substrate at least 3 mm. Typically, the activation force will be in a direction that is substantially parallel to the cross-machine direction (CD) and substantially perpendicular to the major rib axis, described in more detail herein below. It is to be understood that other directional forces having a directional component substantially parallel to the CD and/or substantially perpendicular to the major rib axis may also be suitable, as long as the applied force causes a portion of the substrate to protrude out of the x,y plane of the substrate as described herein.

“Dispensing force” refers to the force required to remove a wipe from a wipes container. Typically, the dispensing force is the force exerted by a user of the wipes pulling one or more wipes all the way or substantially all the way out of the container. The dispensing force may be in a direction that is substantially parallel to the activation force or even within forty-five degrees of the direction of the activation force, but need not necessarily be so.

“Color” as used herein refers to a property of a surface or substance resulting from absorption of certain wavelengths of light and reflection of others. Typically, wavelengths of light between (approximately) 370-760 μm are adequate to excite the retinal receptors of a person.

“Contrasting color” as used herein refers to colors that have a ΔL, Δa and/or Δb value of greater than 3, according to the Hunter L, a, b color scale.

“Comprising” as used herein means that various components, ingredients or steps can be conjointly employed in practicing the present invention. Accordingly, the term “comprising” encompasses the more restrictive terms “consisting essentially of” and “consisting of.”

The term “machine direction” (also “MD”) as applied to a film or nonwoven material, refers to the direction that was parallel to the direction of travel of the film or nonwoven as it was processed in the forming apparatus. The “cross-machine direction” (also “CD”) refers to the direction perpendicular to the machine direction and in the plane generally defined by the film or nonwoven material.

Markush language as used herein encompasses combinations of the individual Markush group members, unless otherwise indicated.

As noted above, the activation force of a wipe is the force applied to the wipe which causes the wipe to thicken (i.e., extend out of the x,y plane of the wipe). Without wishing to be bound by theory, it is believed that thickening occurs as a result of at least a portion of the textured regions protruding out of the x,y plane of the wipe when the wipe is removed from a suitable dispenser. Activation forces of the wipes of the present disclosure may be from 0.4 to 1.5 N, from about 0.6 to 1.2 N, or from 0.8 to 1.0 N. Both the activation force and the thickness of a wipe (before and during activation) are measured according to the method described below.

A useful dispensing force may be one that is greater than the activation force of the wipe being dispensed. Without wishing to be bound by theory, it is believed that the dispensing force required to pull a wipe from a dispenser is a function of at least two forces: (1) pull-out force; and (2) separation force. Dispensing force is measured as described below. Examples of useful dispensing forces include forces from 0.4 to 5.0 Newtons (N), from 1.0 to 4.5 N, or from 2.0 to 4.0 N.

The “pull-out force” as referred to herein is the amount of force that is needed for a single wipe to be pulled through a dispenser orifice. Non-limiting factors that may impact pull-out force include the orifice geometry, the flexibility of the material from which the orifice is made, and the friction generated between the orifice and the wipe as the wipe is pulled through the orifice.

The “separation force” as referred to herein is the amount of force that is needed to overcome wipe to wipe interactions. Wipe to wipe interactions may be described by the bond established between wipes due at least in part by surface-to-surface adhesion resulting from fiber interaction and in the case of wet wipes, lotion interaction.

Considering the foregoing, the components of the present apparatuses may be chosen so as to provide a dispensing force that is greater than the activation force of the wipes. Any suitable combination of elements may be of use and may include a choice of: a dispenser, a dispenser orifice; a wipes configuration in the dispenser; wipes; and wipe texture.

### I. DISPENSER

Any dispenser capable of holding wipes in the desired configuration and including a suitable orifice may be of use. One of skill in the art may chose from a number of known dispensers depending upon the desired result. For example, suitable dispensers may be liquid impermeable. Thus, in embodiments in which it is desirable to store wet wipes in a dispenser, a liquid impermeable dispenser may be used. However, it is to be understood that liquid permeable containers are also contemplated.

According to the present disclosure, a wipe may be viewed against an area of the dispenser proximate the orifice during dispensing, i.e., the dispenser may serve as a backdrop to viewing a wipe during dispensing. Thus in some embodiments, at least a portion of the dispenser proximate to the orifice has a contrasting color to that of the wipe. Without wishing to be bound by theory, it is believed that the contrasting color increases the visibility of the increase in thickness of a wipe during dispensing. In some embodiments, the inside of the dispenser lid may be a contrasting color. In some embodiments, an area adjacent to the orifice may be a contrasting color. In some embodiments, the whole dispenser lid may be a contrasting color. In yet further embodiments, the whole dispenser may be a contrasting color. For example, in some embodiments the wipes are a hue of white, whereas the dispenser is purple.

In some embodiments, the dispensers may comprise an indicium which signals to the consumer that the wipes inside the dispenser increase in thickness during dispensing. Any suitable indicium is of use. Non-limiting examples include: words, phrases, symbols, figures and cartoons.

### II. DISPENSER ORIFICE

Any one of a number of orifice shapes, sizes and or materials may be used in the current invention, as long as the orifice is configured so that the wipe, when dispensed through the orifice, is subjected to a dispensing force that is greater than the activation force of the substrate. A smaller orifice, relative to the dimensions of the wipe, may result in an increased dispensing force, as the forces acting on the wipe as it passes through a relatively smaller hole typically increase.

The orifice may be a simple two-dimensional opening, or the orifice may include an opening that is partially or completely covered by one or more flaps, except during dispensing. Without being bound by theory, it is believed that the presence of flaps over the opening increases the dispensing force. The flexibility of flaps may be adapted such that when a wipe is pulled through the orifice, the flaps partially engage the surface of the wipe without tearing the substrate or otherwise undesirably altering the integrity of the substrate.

With regard to orifice shape, any suitable two-dimensional polygonal, curved or other stylized shape may be used herein. Non-limiting examples of orifice shapes that may be useful in the current invention include circles, ovals, S-shaped openings, squares, rectangles, triangles and/or any other stylized shape based thereon.

Further, the orifice may be made from a relatively rigid material such as thermoplastic materials including polypropylene (PP), polyethylene (PE), polystyrene, polyethyleneterephthalate (PET), polypropylene/polyethylene co-polymers, and combinations thereof. A relatively rigid orifice made from a thermoplastic material will typically have a thickness of 1 mm or from 0.4 mm to 2 mm. However, it is to be understood that any thickness of orifice may be suitable for use herein, as desired. The orifice may be made from a relatively flexible material such as a thermoplastic material such as films and/or laminate films made from polypropylene, polyethylene, polystyrene, polyethyleneterephthalate, polyvinylchloride, oriented polypropylene, and combinations thereof. A relatively flexible orifice made from a thermoplastic material will typically have a thickness of 70 um, or from 20 um to 400 um. The relatively flexible orifice material may also be an elastomeric material such as a thermoplastic elastomer such as styrenic elastomers, styrene-butadiene-styrene elastomers, Styrene-ethylene-butadiene-styrene elastomers, plasticized PVC, and combinations thereof. In certain embodiments, a relatively flexible orifice made from a thermoplastic elastomer may have a thickness of from 10 um to 3 mm. The relatively rigid orifices may result in increased dispensing forces compared to relatively flexible material at least in part due to the relative differences in flexibility in the two materials.

The orifice may be an oval with dimensions of 55 mm by 25 mm made from polypropylene/polyethylene co-polymers with a thickness of 1 mm for dispensing a wipe with dimensions of 180 mm by 180 mm.

The orifice may be a circle with diameter of 48 mm made from polypropylene/polyethylene co-polymers with a thickness of about 1 mm for dispensing a wipe with dimensions of 190 mm by 105 mm.

The orifice may be an S-shaped opening with dimensions of 55 mm by 25 mm made from polypropylene/polyethylene co-polymers with a thickness of about 1 mm for dispensing a wipe with dimensions of 200 mm by 160 mm or for dispensing a wipe with dimensions of 179 mm by 170 mm.

The orifice may be an oval with dimensions of 60 mm by 30 mm made from a PP/PET laminate film with a thickness of 70 um for dispensing a wipe with dimensions of 200 mm by 160 mm or for dispensing a wipe with dimensions of 179 mm by 170 mm.

The orifice may be an oval with dimensions of 38 mm by 20 mm made from a PP/PET laminate film with thickness of 70 um for dispensing a wipe with dimensions of 200 mm by 160 mm.

The orifice may be an oval with dimensions of 45 mm by 30 mm made from a PP/PET laminate film with thickness 70 um for dispensing a wipe with dimensions of 200 mm by 160 mm or for dispensing a wipe with dimensions of 179 mm by 170 mm.

The orifice may be a circle with a diameter of 25 mm made from a PP/PET laminate film with thickness 70 um for dispensing a wipe with dimensions of 190 mm by 105 mm.

### III. WIPES CONFIGURATION

One non-limiting example of a wipes configuration includes a plurality of wipes folded and stacked in a container. Another example includes wipes that wound into a roll. Wipes may be folded in any of various known folding patterns; non-limiting examples include C-folding, Z-folding and quarter-folding. Use of a Z-fold pattern may enable a folded stack of wipes to be interleaved with overlapping portions. In some embodiments, the individual wipes may be attached end-to-end by known means including, but not limited to, using adhesives. Wipes configurations are disclosed more fully in commonly assigned U.S. Pat. No. 6,960,349.

In some embodiments, the wipes may include a continuous strip of material which has perforations between each wipe and which may be arranged in a stack or wound into a roll for dispensing, one after the other, from a container. In some embodiments the aforementioned continuous strip of material is lengthened by adhering it to a further like strip on one or both of its ends before it is stacked or wound into a roll.

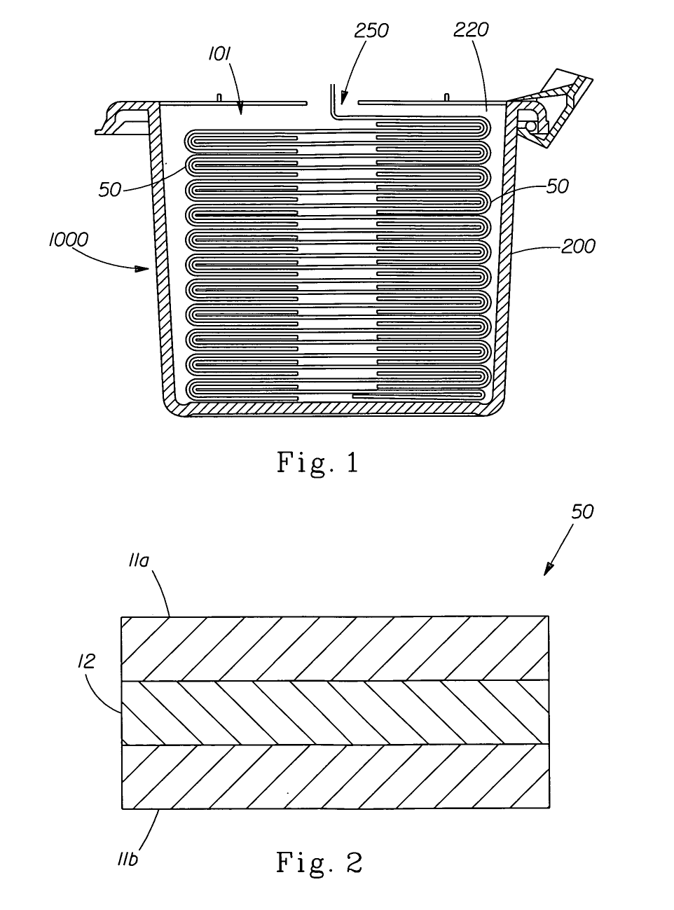

FIG. 1 shows one embodiment of a suitable apparatus 1000 as a wipes dispenser 200 having an interior storage space 220, an orifice 250, and containing a plurality of z-folded wipes 50 that are interleaved in a stack 101.

### IV. WIPES

The wipes of the present disclosure may include one or more layers of nonwoven web.

The wipes may also include one or more layers of other material, as desired. The present wipes may have a basis weight of from 30 to 120 grams per square meter (gsm); from 40 to 70 gsm; or from 50 to 60 gsm.

The nonwoven suitable for use herein may be made by any means commonly known in the art, such as, for example spunbonding and meltblowning. Likewise, the nonwovens suitable for use herein may be consolidated using any means commonly known in the art, such as, for example hydroentanglement, thermal calender bonding, through air thermal bonding, chemical bonding, needlepunching, and the like. As used herein, the term “hydroentanglement” generally means a process of making a nonwoven through the treatment of a starting substrate. The treatment typically comprises the steps of supporting a layer of loose fibrous material on an apertured member, and subjecting the layer to water pressures that are sufficient to cause the individual fibers to mechanically entangle with other fibers and possibly other web layers of a substrate. The apertured member can be made from any suitable surface including, but not limited to: a woven screen, a perforated metal plate, and the like. In certain embodiments, the method of making a nonwoven web may include the steps of carding followed by hydroentanglement. The nonwoven webs of the present disclosure may have a dry basis weight of from 15 to 150 grams/meter² gsm, from 20 to 100 gsm, or from 30 to 90 gsm.

Nonwoven webs and fibrous layers used herein may be made from fibers chosen to provide desired end properties in the wipe including, but not limited to: softness, thickness, and strength. Specifically, it may be desirable to provide wipes that are strong enough to withstand the mechanical stress associated with providing the thicker wipes described herein. Examples of suitable fibers include thermoplastic fibers, non-thermoplastic fibers and mixtures thereof. The fibers and combinations of fibers may additionally comprise a certain percentage of each layer of the laminates as: multi-component, or conjugate fibers, such as bicomponent fibers; biconstituent fibers; non-round fibers; and combinations thereof.

Wipes comprising more than one layer may be composites. The layers that make up a composite are held together via inter-layer bonding. Inter-layer bonding may be achieved via any suitable method that provides for intertwining of enough fibers between the layers such that the composite will typically not de-laminate. Non-limiting examples of such inter-layer bonding processes include, but are not limited to spunlacing (hydroentanglement); hydroforming; and combinations thereof. Although a structure of separate layers may permit preferential distribution of fiber types, it may be desirable for the constituent layers to perform as a unitary web when utilized as a wet wipe. This may be particularly desirable in a baby wipes application, since de-lamination of the layers during use typically detracts from the consumer benefits delivered from such a wet wipe. Methods of manufacturing composites are discussed in further detail in U.S. Ser. No. 60/787467.

Referring now to FIG. 2, a schematic representation of a cross-sectional view of one embodiment of a wet wipe is shown prior to the mechanical manipulation that will provide it with texture. The wipe 50 may be configured as a composite that includes two outer layers 11A and 11B of spunbond synthetic nonwoven webs and an inner layer 12 of pulp. The layers 11A, 11B, and 12 may be bonded together via spunlacing. Bonding between the layers may occur as a result of the transfer of energy from the water to the composite during the spunlacing (hydroentanglement) process. The energy transfer may cause the pulp fibers of the inner layer 12 to intertwine with synthetic fibers of the outer layers 11A and 11B. It is further hypothesized without being bound thereto, that this intertwining of the inner layer 12 and outer layers, 11A and 11B, may provide a pore size gradient across the layers. In some embodiments, the pore size may decrease as the liquid moves from the outer, largely synthetic portions of the pre-moistened wipe 50 to the inner, largely pulp-containing portions of the wipe 50, and vice versa. It is believed that the pore size gradient may aid in the transfer of lotion to and from the inner layer 12. Consequently, the interlayer bonding step may be particularly desirable as it can contribute to the fluid retention properties of the pre-moistened wipes 50 when they are in a stack, as well as to their lotion expression ability when subjected to typical in-use forces.

### V. WIPE TEXTURE

Wipes according the present disclosure may have a plurality of first and second regions that provide a sensation of texture to a user. The texture may cause a user to perceive the wipes as having the thickness and feel typically associated with cloth, even when the wipes are pre-moistened. The texture may also provide the wipes with good cleaning and liquid retention characteristics.

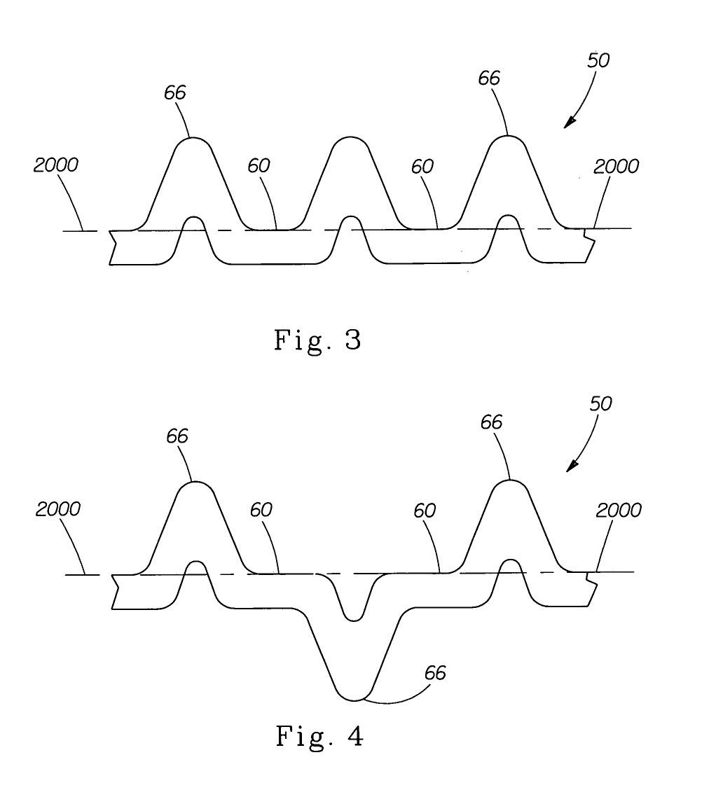

FIGS. 3 and 4 show portions of a wipe 50 forming an x,y plane 2000. The x,y plane 2000 is defined by the generally two-dimensional configuration of the nonwoven layer or composite before it is mechanically manipulated, such as, for example by the SELFing or embossing method described in U.S. Pat. No. 5,916,663 or U.S. Publication No. 20050215970. Referring now to FIG. 4, the first regions 60 may be substantially disposed in the x,y plane 2000 of the wipe 50 while at least some of the second regions 66 protrude out of the x,y plane 2000 of the wipe 50 in a first direction, prior to dispensing through a dispenser orifice. During dispensing, at least a portion of the second regions 66 may undergo displacement such that they protrude farther out of the x,y plane 2000 (i.e., in the first direction) than they did prior to dispensing, and a portion of the second regions 66 may undergo displacement such that they protrude out of the x,y plane 2000 of the wipe in a second direction, which is substantially opposed to the first direction, as shown for example in FIG. 4.

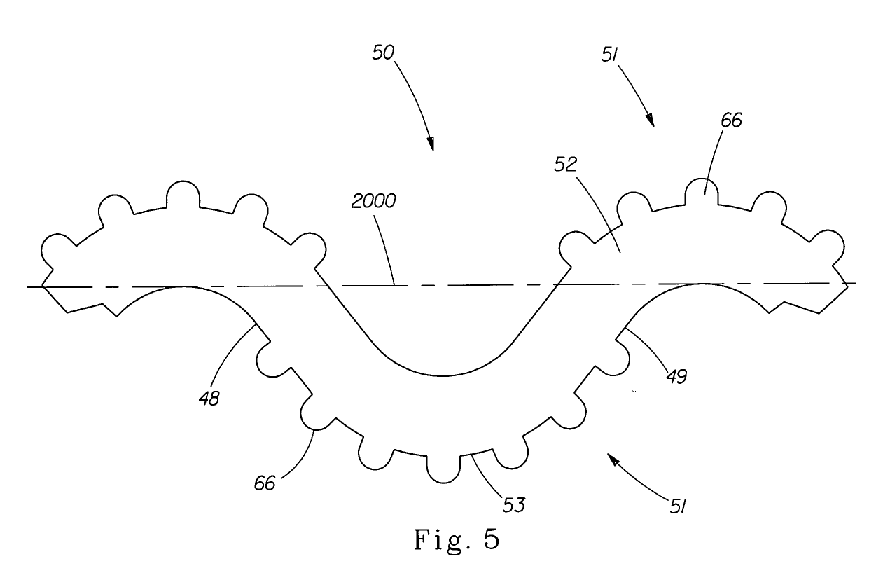

FIG. 5 shows another example of the second regions 66 protruding out of the wipe surface 49 in response to an activation force. In certain embodiments the wipe 50 may include a flexible substrate 48. When the wipe 50 is in a substantially flat out state, first regions 60 are disposed in the x,y plane 2000, but when the wipe 50 is dispensed from a container, the wipe surface 49 may develop peaks 52 and valleys 53 (e.g., become wrinkled) in response to the various forces being applied to the wipe. As shown in FIG. 5, the second regions 66 may protrude out of the wipe surface 49 in a direction that is substantially the same as the direction of the peak 52 or valley 53, relative to the original x,y plane 2000. In other words, if a peak 52 is viewed as extending “up” (i.e., extending toward a viewer if the wipe were laid flat out and viewed from above) then the second regions disposed on the peak may also generally extend up. If a valley 53 is viewed as extending down (i.e., extending away from a viewer if the wipe were laid flat out) then the second regions disposed on the valley may also generally extend down. However, when uniform force is applied to the entire length of each of the opposing sides of the wipe 50, it may be possible to have all of the second regions 66 of the wipe 50 protrude in the same direction.

Whether a particular part of the wipe forms a peak or a valley may depend whether force is applied uniformly along opposing sides of the wipe or intermittently. For example, when a user holds the wipe with his or her hands on opposite edges of the wipe and attempts to stretch the wipe, the force exerted by the user may be observed as causing the surface of the wipe to form one or more substantially straight-line peaks between the portion of the user's hand actually contacting the wipe (e.g., the user's fingers). Without being limited by theory, it is believed that the peaks may form as a result of “necking,” whereby the material is contracting in a direction substantially perpendicular to the strain of the substrate. The peaks may be formed at a plurality of regions in the wipe surface, for example where the user's hands are applying force to discrete regions of the wipe and the regions are spaced apart. The portions of the wipe that are disposed between the regions having force applied thereto may manifest as valleys between the peaks.

The first and second regions of the wipes may be visually distinct from one another. In addition to first regions being visually distinct from second regions, the first regions may bound the second regions such that the second regions form visually distinct patterns on a web of the present disclosure. Examples of such visually distinct patterns are disclosed herein, and include, but are not limited to: regular patterns of diamond-shapes; wavy, undulating patterns; regular patterns of triangle-shapes; strips; blocks of first and second regions intermittently spaced; islands of second regions in first regions or vice versa; combinations of shapes and/or patterns; and the like. The size of the second region and/or the visual pattern formed from the relationship of the first and second region may vary, as desired. In some instances, it may be desirable to have only one second region per 2.54 linear cm in the CD of the wipe. In other instances, it may be desirable to have 2 second regions per 2.54 linear cm in the CD of the wipe. In still other instances, it may be desirable to have between 2 and 5 second regions per 2.54 linear cm in the CD of the wipe.

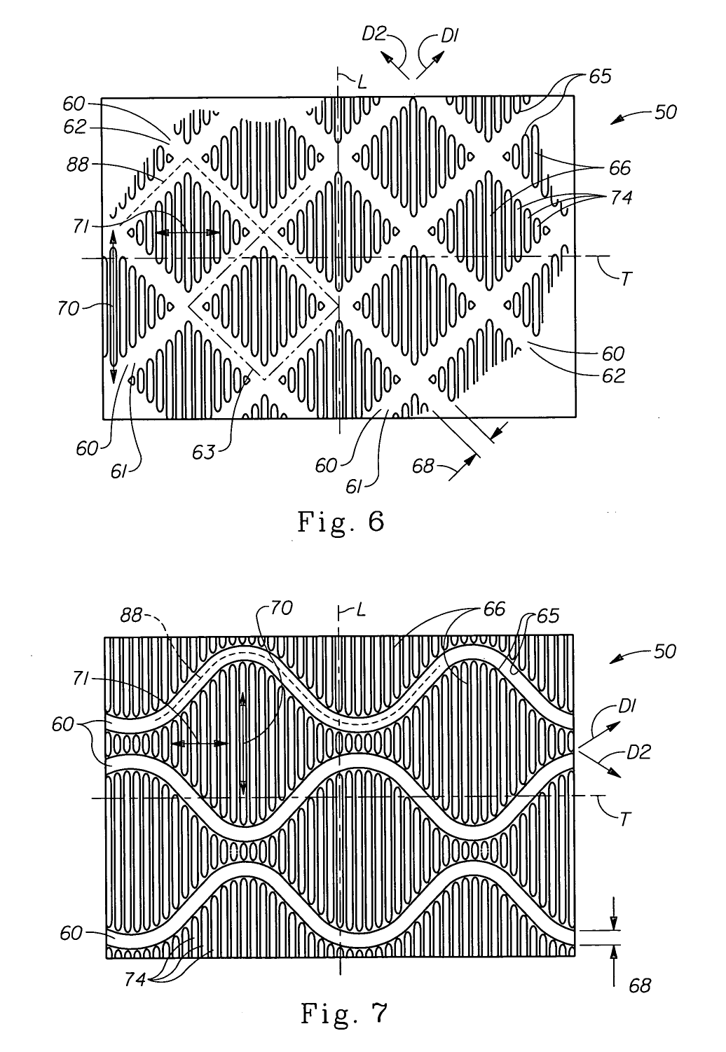

Referring to FIGS. 6 and 7, two embodiments are shown of pre-moistened wipes having texture according to the present disclosure. The presently disclosed wipes 50 have two centerlines, a longitudinal centerline, which is also referred to hereinafter as an axis, line, or direction “L” and a transverse or lateral centerline, which is also referred to hereinafter as an axis, line, or direction “T”. The transverse centerline “T” is generally perpendicular to the longitudinal centerline “L”. In the process of making the layer(s) of nonwoven web which comprise the wipe, the longitudinal centerline can be parallel to the MD, and the transverse centerline can be parallel to the CD.

The wipe 50 includes a strainable network of distinct regions. As used herein, the term “strainable network” refers to an interconnected and interrelated group of regions which are able to be extended at least 10% in a predetermined direction. Additionally, the strainable network may provide the wipe 50 with elastomeric properties such that it exhibits elastic-like behavior in response to an applied and subsequently released force.

The strainable network may include a plurality of first regions 60 and a plurality of second regions 66. The wipe 50 may also include one or more transitional regions 65 located at the interface between the first regions 60 and the second regions 66. The transitional regions 65 may exhibit complex combinations of the behavior of both the first region 60 and the second region 66. It is recognized that the various embodiments of the present disclosure may have transitional regions; however, the present disclosure is largely defined by the behavior of the web material in the first regions 60 and second regions 66, since the overall wipe behavior is not significantly dependent upon the complex behavior in the transitional regions 65.

While first regions 60 are described herein as a plurality of first regions 60, it is appreciated that in some embodiments, such as the embodiment of FIG. 7, the plurality of first regions 60 may form a single, interconnected, continuous network region. As used herein, therefore, the term “plurality of first regions 60” encompasses interconnected first regions which form a single, continuous network region. Although interconnected into a single, continuous network region, first regions 60 can still be considered discrete, interconnected, and intersecting regions. For example, see regions 61 and 62, which are described below.

The wipe 50 has a first surface, (facing the viewer in FIGS. 6 and 7), and an opposing second surface (not shown). In the embodiment shown in FIG. 6, the strainable network includes a plurality of first regions 60 and a plurality of second regions 66. One set of first regions 60, indicated generally as 61, may be linear and extend in a first direction, denoted generally as D1. The remaining first regions 60, indicated generally as 62, are linear and extend in a second direction, denoted generally as D2, which is substantially perpendicular to the first direction. While in this embodiment, the first direction is perpendicular to the second direction, other angular relationships between the first direction and the second direction may be suitable. For example, the angle between the first and second directions can range from 45° to 135°, and can be 90°. The intersection of the first regions 61 and 62 can form a boundary, indicated by boundary line 63 in FIG. 6, which completely surrounds the second regions 66.

It is not necessary that intersecting first regions 61 and 62 be generally straight, as in the embodiment shown in FIG. 6. Furthermore, it is not necessary that first regions 60 be intersecting. FIG. 7 shows an example of a wipe 50 including first regions 60 that are generally wavy and non-intersecting. In contrast to forming a pattern similar to that of FIG. 6, in which first regions 60 completely bound second regions 66, the wavy, non-intersecting first regions 60 shown in FIG. 7 at least partially separate, but do not completely bound, second regions 66.

In some embodiments, the width 68 of the first regions 60 may be from 0.05 cm to 0.254 cm, and in further embodiments it may be from 0.076 cm to 0.127 cm. However, other width dimensions for the first regions 60 may be suitable. In one embodiment, such that as shown in FIG. 6, the first regions 61 and 62 may be perpendicular to one another and equally spaced apart, resulting in second regions having a generally square or diamond shape. In certain embodiments, first regions 61 may have a width of 0.102 cm and be configured in a parallel relationship on a 1.37 cm center to center spacing. However, other shapes for the second region 66 are suitable and may be achieved by changing the spacing between the first regions and/or the alignment of the first regions 61 and 62 with respect to one another.

One notable attribute of first regions 60 is the formation of a generally “reticulated structure”, a portion of which is illustrated in FIGS. 6 and 7, as dashed line 88. By “reticulated structure,” with reference to first regions 60, it is meant that portions of the first region 60 divide portions of the second regions 66 so as to form a network. The reticulated structure of the first regions 60 may be modeled as a two-dimensional spring, which provides some extensibility and restorative forces in the plane of the web and allows for some web elasticity. It is to be understood that the first regions exemplified in FIGS. 6 and 7 are illustrative of patterns for first regions 60, and are not intended to be limiting.

First regions 60 may be substantially macroscopically planar. The first regions 60 may remain substantially unmodified by subsequent processing such that they experience little or no out of plane deformation. That is, the material within the first regions 60 may be in substantially the same condition before and after any processing steps undergone by the wipe 50. Thus, the first regions may substantially be in the x,y plane of the wipe.

The second regions 66 may include a plurality of protrusions, or raised rib-like elements 74. The rib-like elements may comprise ridges and furrows. The rib-like elements 74 may be embossed or SELFed to form what can generally be described as fan-folded structures. As shown in FIGS. 6 and 7, each fan-folded structure of rib-like elements 74 has a first or major rib axis 70 which is substantially parallel to the longitudinal axis of the wipe 50 and a second or minor rib axis 71 which is substantially parallel to the transverse axis of the wipe 50. For each rib-like element 74, the major rib axis 70 is substantially perpendicular to the minor rib axis 71. The rib-like elements 74 can be contiguous, having no unformed areas between them.

The major rib axis 70 and minor rib axis 71 of the raised rib-like elements may be oriented relative to the plane of the wipe in ways other than shown in FIGS. 6 or 7, for example by orienting the major rib axis 70 substantially parallel with the transverse axis of the wipe. Many benefits of the present disclosure may be realized even when the major axes 70 of each rib-like element 74 are not aligned parallel to one another.

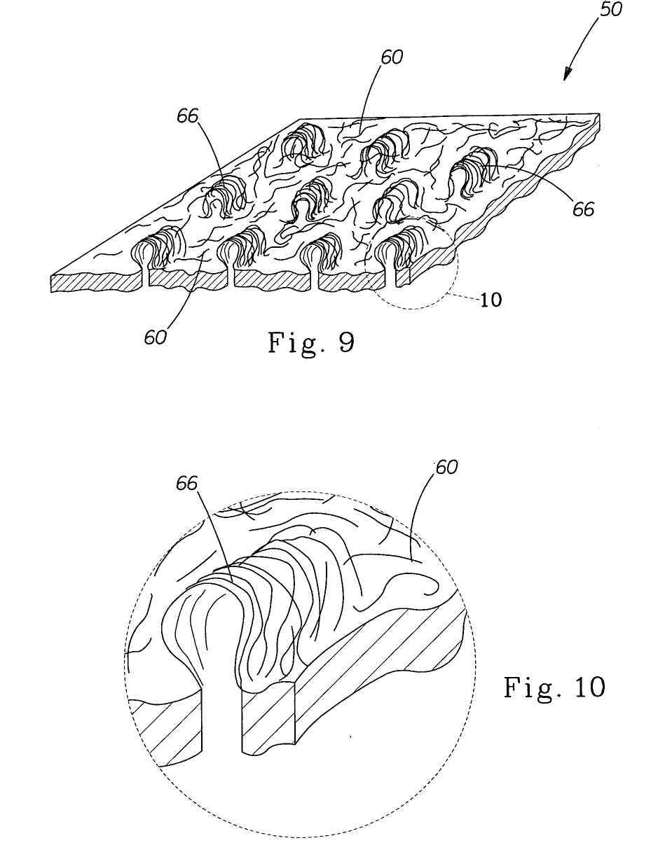

As the wipe 50 is subjected to an applied elongation force in the transverse direction, indicated by arrows 80 in FIG. 9, the rib-like elements 74 in the second regions 66 experience deformation, or unfolding, and offer relatively little resistance (as compared to the longitudinal direction) to the applied elongation. In addition, the shape of the first regions 60 changes as a result of the applied elongation force, due to the ability of the reticulated structure formed by the first regions 60 to act as a two-dimensional spring. When the first regions 60 experience deformation, the second regions 66 will typically experience a change in shape as well, since first regions 60 border, separate, and in some instances, bound second regions 66.

Accordingly, as the wipe 50 is subjected to the applied elongation force, the reticulated structure of the first regions 60 experience deformation and tend to straighten out. The deformation of the first regions 60 in turn causes the second regions 66 to extend or lengthen in substantially the same direction as the direction of applied elongation force and shorten in a direction perpendicular thereto. In addition, other modes of deformation may be observed, as disclosed more fully below.

As can be seen in FIGS. 6 and 7, first regions 60, whether intersecting or not, generally have portions which extend in either first direction D1 or second direction D2. In certain embodiments, the first and/or second directions D1 or D2 may be configured such that neither is parallel to the major or minor rib axes 70 or 71. Alternatively, D1 and/or D1 may be configured such that one is parallel with the major or minor rib axes 70 or 71. Portions of first regions 60, such as the point of intersection of first regions 60 in FIG. 6, are minimized, and are believed to have little impact on the extensible or elastomeric properties of the wipe 50.

While it may generally be desirable to minimize the portions of first regions 60 that do not have both major and minor rib axis components 70, 71 (i.e., first regions that are parallel to one axis or the other), benefits of the wipes described herein may be realized with substantial areas of first regions 60 aligned with either the major or minor axes of second regions 66. Such a configuration may be useful in retaining MD tensile strength when major rib axes 70 are in parallel alignment with longitudinal axis L, which in turn corresponds to the MD during web processing. Other configurations are contemplated, such as having some first regions 64 parallel to major rib axes 70, but having the major rib axes 70 in parallel alignment with transverse axis T, which, in turn, can correspond to the CD during web processing.

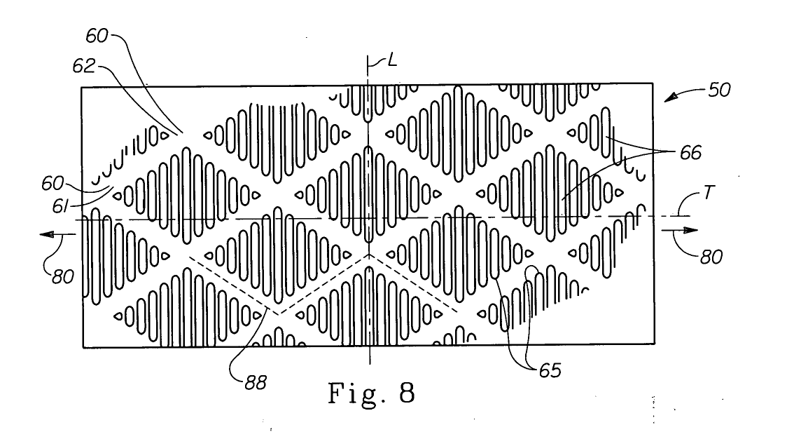

FIG. 8 shows an example of a wipe 50 in an extended state. The extensible, or elastic, nature of the wipe 50 may be due in part to the ability of the fan-folded structure of second regions 66 to “unfold” in a three- dimensional manner along the rib-like elements. The extensible or elastic nature of the wipe may also be due in part to the simultaneous contraction of the network of first regions 60 in a direction generally perpendicular to the applied loading. The contraction of the first regions generally occurs in a two-dimensional, geometric manner in the plane of the wipe 50. The contraction of the network of first regions 60 and resulting shape change of second regions 66 may be considered analogous to a two dimensional Poisson effect. For example, as the wipe 50 is extended in a direction generally parallel to the transverse centerline T, the shape of the second regions 60 changes with one dimension increasing and another dimension decreasing. As discussed above, the simultaneous unfolding of second regions 66, and contraction of first regions 60, is provided for by avoiding substantial parallel alignment of the major or minor axes 70 or 71, with either the first or second directions, D1 or D2 of first regions 60.

The composites of the present disclosure may be imparted with first and second regions, 60 and 66, comprising further patterns as described in the commonly assigned Patent applications and publications listed in the following subsection. For example, referring to FIGS. 9 and 10, the second regions 66 may comprise “tufts” or “loops” 2 as respectively described in co-pending and co-assigned U.S. Ser. Nos. 10/737,306 and 11/155,805.

The present wipes and/or nonwoven layers from which they are made may be imparted with texture via methods described in the following Patent applications and publications: U.S. Pat. Nos. 5,143,679; 5,518,801; 5,650,214; 5,691,035; 5,914,084; 6,114,263; 6,129,801; 6,383,431; 5,628,097; 5,658,639; and 5,916,661; WO Publication Nos.: 2003/0028165A1; WO 2004/059061; WO 2004/058117; and WO 2004/058118; U.S. Publication Nos.: 2004/0131820A1; 2004/0265534A1; WO 2004/0131820A1 (U.S. patent application Ser. No. 10/737,306); and WO 2005/0281976A1 (U.S. patent application Ser. No. 11/155,805).

### VI. METHODS

The physical properties relating to the activation, i.e., thickening of wipes encompassed within the present disclosure, as well as the physical properties of known wipes, are measured as follows. The resulting data is discussed at length in the Examples section below. The physical properties that are measured include: saturation load; dispensing force; wipe thickness; wipe surface texture; and activation force. Each test measurement was conducted at room temperature unless otherwise specified.

1. Saturation Load

The saturation load, often expressed as percent saturation, is defined as the percentage of the dry substrate's mass that the lotion mass represents. For example, a saturation load of 1.00 (equivalently, 100% saturation) indicates that the mass of lotion on the substrate is equal to the dry substrate mass.

The following equation is used to calculate saturation load of one wipe:

$$Saturation Load = [ \frac{wet wipe mass}{( wipe size ) * ( basis weight )} ] - 1$$

2. Dispensing Force

The dispensing force required to remove a wipe from a dispenser with an orifice is performed in a conditioned room maintained at 23° C.±2° C. (73° F.±5° F.) and 50%±5% relative humidity. Start the computer. Install the bottom plate onto the lower stationary shaft of an MTS brand tensile tester. Install a 50 Newton load cell onto the upper moving crosshead and screw-on the manual clamp. Remove lid of tub to be tested and place the tub at the bottom plate with the orifice centered to the clamp. To ensure that the dispenser will not be displaced while executing the test, use double-sided adhesive tape to fix it in position. Enable the MTS tensile tester and move the crosshead up/down, so that the clamp is at maximum altitude 2 cm above the tub-orifice (Start Point). Restart the tensile tester, start the TestWorks™ software and calibrate the load cell (calibrate the tensile tester according to the manufacture's instructions or SOP before beginning any testing).

### Equipment Setup

1. Crosshead speed—169.35 mm/second
2. Data acquisition rate—150 Hz
3. Gage Length (Start Point)—User defined
4. Data collection Start Marker—0.05 mm (from start point=Peel Start)
5. Data collection End Marker—225 mm (from start point=Peel End)
6. Pull end point—225 mm (from start point=End Point)
7. Break Detection—disabled
8. Preload—set crosshead to “no preload”
9. Enter calculation for Average Pull-out-Force: AverageValue(_Load,PeelStart,PeelEnd)
10. Enter calculation for Peak Pull-out-Force: PeakValue(_Load,PeelStart,PeelEnd)

### Procedure

Remarks for test execution:
   a) Remove the package of the wipes.
   b) Carefully take one wet wipe out of the middle of the stack, unfold it without stretching it and insert it in the tub.
   c) Pull the middle part of the top wing through the orifice such that the wipe edge is 2.5 cm above the orifice (no corners out), close the tub and carefully fix this part of the wipe (Leading Edge, LE=2.5 cm) in the clamp, close the clamp. This step should to be performed relatively quickly, with minimal handling of the wipes in order to avoid dry out. Ensure that the orifice is centered under the clamp.
   d) Go to test segment of software and begin test.
   e) Repeat points b), c) and d) for 30 wipes.

For one orifice-product combination the measurement of one series is advisable. One series=30 wipes. Load is recorded in grams-force or Newtons.

### Calculations and Reporting

The average and the maximum peak Pull-out-Force of the individual Pull-out Force (peak) value is calculated (1 series=30 values each).

### Report:

A. Detailed product information (LOT-number)
B. Average of max PF in N: x̅[N]
C. Compare average max PF of same orifice for different products (if necessary) and keep track of significant distinctions.
D. Standard deviation in N: σ[N]

3. Activation Force

Activation Force is measured according to EDANA method 20.2-89 using an MTS tensile tester to record the relationship between force and strain or load and strain for a 50 mm wide sample. For this test, samples are cut to 180 mm length in the MD and 50 mm length in the CD. Due to the size of the samples, an initial jaw separation of 100 mm is used.

4. Wipe Thickness

Wipe thickness is measured with a ProGage™ Thickness Tester (SN 44722) from Thwing-Albert, N.J., USA, and EDANA 30.4-89 instrument requirements. For this test, 5 samples are cut to 90 mm in CD and 180 mm in MD. The samples are first tested for thickness under normal relaxed conditions. Then the samples are tested under strained or elongated conditions. For the strained or elongated conditions reference lines were marked 60 mm apart on the samples perpendicular to the direction of strain. The samples are then manual strained or elongated in 5 mm increments up to 80 mm which correspond to 8.3%, 16.7%, 25%, and 33% strain. The thickness at each of these strained or elongated conditions in then recorded.

5. Wipe Surface Texture

The surface texture of a wipe is measured using an optical 3D measuring device also known as MikroCAD Optical Profilometer by GFM™ (GFMesstechnik GmbH, Germany). The measuring device utilizes a CCD (Charged Coupled Device) camera coupled with a stripe light projector (SLP) where the object to be measured is angular lighted under a defined angle (45°) with an array of equidistant stripes. The projected stripe patterns (recorded by the camera) have a cos² dependent intensity distribution and can be evaluated as interferograms. Thus, height information is included in stripe position as well as the grey value providing high resolution of surface geometries. Image analysis software provided by GFM™ (ODSCAD 5.075 E) is utilized for characterizing texture (heights and ridges) on nonwoven samples.

Test samples of a wipe are cut to 18 cm length in the MD and 10 cm length in the wipes' CD. For these samples the MikroCAD optical profilometer from GFMesstechnik GmbH is used to measuring texture (height, ridges) for the samples. The measurement is performed on both sides of the samples in a relaxed state without any strain and after about 25% strain in the CD. All the images are scaled and calibrated before measuring the actual heights in millimeter (mm) or micrometers (μm). A dot is marked on each of samples to enable a repeatable positioning of the instrument from side to side.

### VII. EXAMPLES

Each of examples 1, 2 and 3, provides a wipe having a unique surface texture when dispensed through a suitable dispenser orifice.

### Example 1

A pre-moistened wipe is prepared according to the present disclosure as follows. A polyethylene-polypropylene bicomponent fiber substrate, manufactured by BBA Fiberweb, Simpsonville, S.C., U.S.A., is the starting spunbond. This spunbond is a 15 gsm spunlaid nonwoven comprising about 3.0 denier fibers (denier is the mass in grams per 9,000 linear meters of fiber) that are thermally bonded. The pulp is about 38 gsm Southern Softwood Kraft pulp with no additional wet chemical additives such as wet strength resins. The composite is formed by layering two outer layers of the spunbond nonwovens with an inner layer of pulp and hydroentangling to the extent that the fibers from the layers are intertwined. The composite is then processed to impart a texture with substantial first and second regions, for example by SELFing. The composite has a basis weight of 68 gsm. The substrate also had a lotion load of about 3.0 g/g by weight of the substrate.

### Comparative Example 2

A pre-moistened wet wipe currently sold under the Pampers™ brand, by the Procter & Gamble Company, Ohio, USA, comprises about 60% polypropylene and 40% rayon staple fibers which are hydroentangled together to form a substrate. During hydroentanglement, a circular pattern designated 910P and supplied by the Reiter Company, France is imparted or hydro-molded into the substrate. The substrate also has a design of clouds and ducks which is imparted into the substrate via thermal calendering. The basis weight of the substrate is about 58 gsm. The substrate has a lotion load of about 3.4 g/g by weight of the substrate.

### Comparative Example 3

A pre-moistened wet wipe currently sold under the Huggies™ brand by Kimberly-Clark, Wisconsin, USA, contains outer layers of a homogenous mixture of pulp and meltbown polypropylene fibers and an inner layer of elongated elastic synthetic fibers oriented in the machine direction. The layers are thermally bonded together to create a rippled texture. The basis weight of the substrate is about 70 gsm. The substrate also had a lotion load of about 3.4 g/g by weight of the substrate.

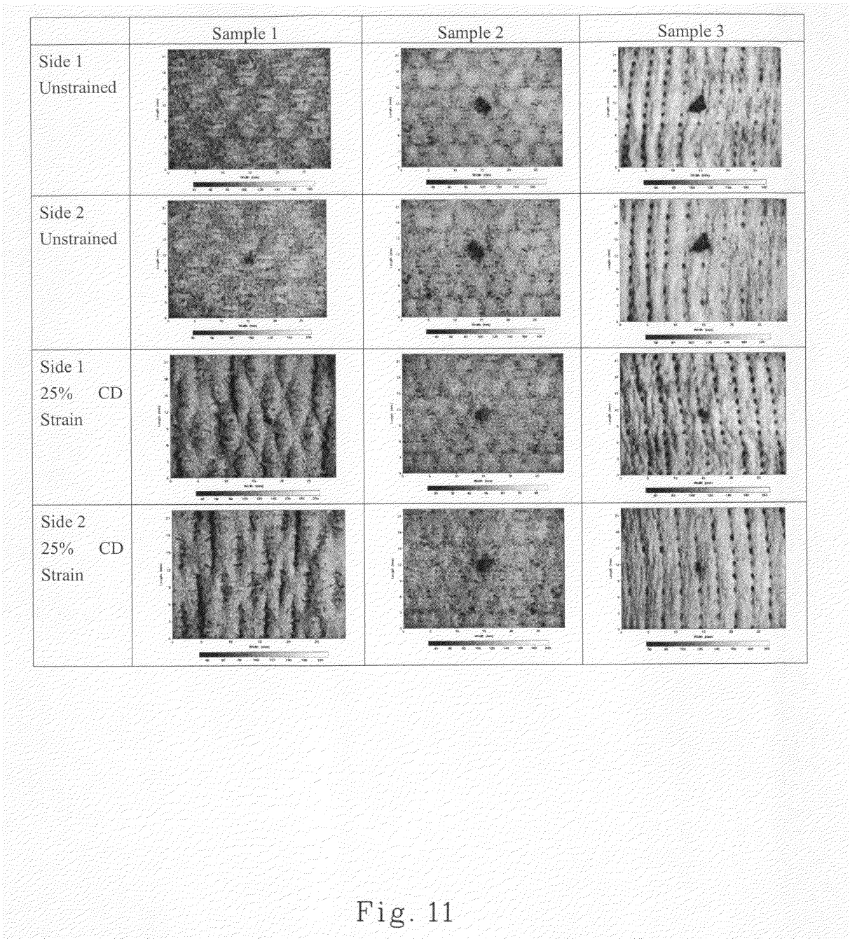

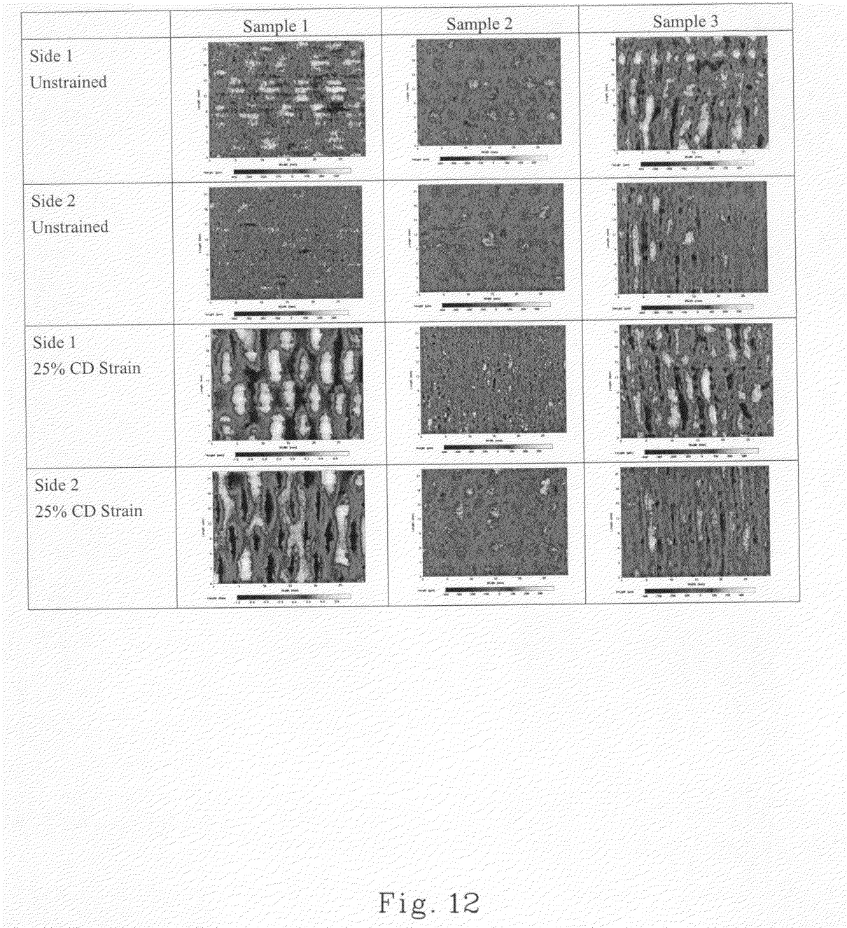

FIG. 11 shows the photographs of each of side of examples 1, 2 and 3 in: (1) a relaxed state and (2) strained to 25% in the CD. FIG. 12 shows the results from MikroCAD optical profilometery for each of side of examples 1, 2 and 3 in a relaxed state and strained to 25% in the CD.

FIGS. 11 and 12 demonstrate that in the relaxed state, example 1 has more substantial texture on side 1 versus side 2, where as examples 2 and 3 have about the same level of texture on both sides. FIG. 11 also demonstrates that for example 1, significant texture is created by straining the substrate in the CD direction. This can be seen in the change of scale for the texture height measurement from +/−400 um to +/−1.2 mm. FIG. 11 also shows that the texture in example 1 becomes more substantial on both the top and bottom sides of the wipe. For examples 2 and 3, no significant change in texture or reorientation occurs as a result of straining the wipe by 25%.

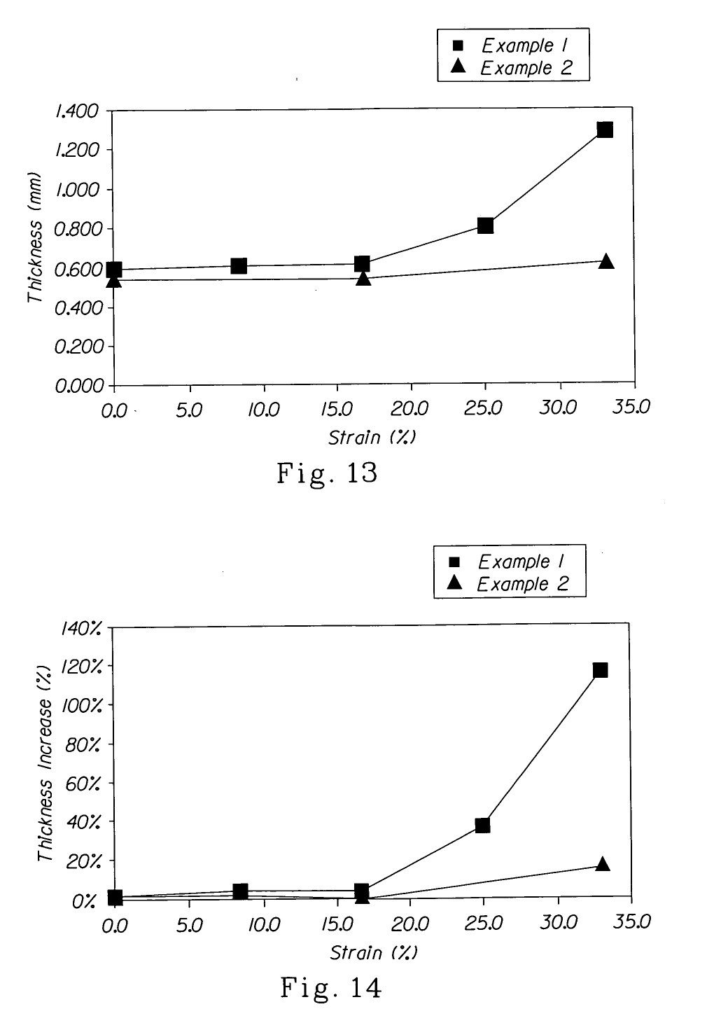

FIGS. 13 and 14 demonstrate the relationship between thickness and strain. Thickness is measured by EDANA 30.4-89 (February 1996) as discussed supra. The substrates are tested under normal relaxed conditions as well as under various strains corresponding to the known strains. The results show that for example 1 significant thickness (about 20% to 120% increase) is generated by applying strains ranging from 20% up to 35% strain. In contrast, example 2 remains relatively unchanged when subjected to the same strains.

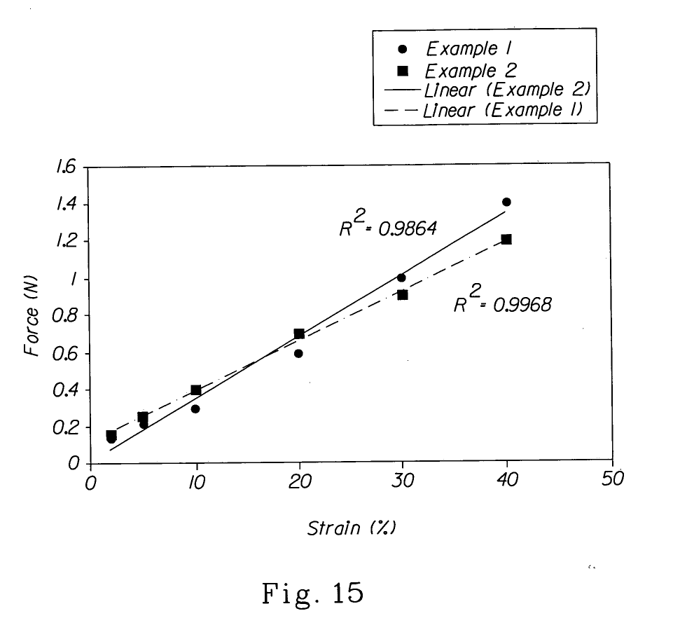

FIG. 15 demonstrates the relationship between force or load and strain for a 50 mm strip of examples 1 and 2. The relationship is measured using EDANA method 20.2-89 with an MTS tensile tester. This figure shows that 25% CD strain corresponds to about 0.8 N of force.

Peak dispensing force is measured using the method described supra. The force required to pull example 1 through the dispensing orifice ranges from about 1.5 to 4 Newtons. Thus, the force to activate a wipe, i.e., increase its thickness and texture, is less than the force required to dispense the wipe through the orifice.

Without being bound by theory, the substantial increases in thickness and texture under strain results from the relative modulus of elasticity difference between the first and second regions. Under the overall strain on the wipe, the first regions tend to deform to a lesser extent than the second regions, enabling expansion of the second regions. The relative flexibility of the second regions may also allow for them to: (1) visibly increase in height, and/or (2) undergo displacement such that they protrude below the plane of the wipe during dispensing.

The dimensions and values disclosed herein are not to be understood as being strictly limited to the exact numerical values recited. Instead, unless otherwise specified, each such dimension is intended to mean both the recited value and a functionally equivalent range surrounding that value. For example, a dimension disclosed as “40 mm” is intended to mean “about 40 mm”.

All documents cited in the Detailed Description are, in relevant part, incorporated herein by reference; the citation of any document is not to be construed as an admission that it is prior art with respect to the present disclosure. To the extent that any meaning or definition of a term in this document conflicts with any meaning or definition of the same term in a document incorporated by reference, the meaning or definition assigned to that term in this document shall govern.

While particular embodiments of the present disclosure have been illustrated and described, it would be obvious to those skilled in the art that various other changes and modifications can be made without departing from the spirit and scope of the disclosure. It is therefore intended to cover in the appended claims all such changes and modifications that are within the scope of this disclosure.

What is claimed is:

1. An apparatus for dispensing wipes comprising:
a. a dispenser including an interior storage space for storing a plurality of wipes and an orifice for providing access to wipes stored in the interior storage space; and
b. a plurality of wipes disposed in the interior space of said dispenser, each wipe having:
i. an x,y plane;
ii. an activation force; and
iii. a thickness;
wherein when at least one of said wipes is removed from the interior storage space, at least a portion of one of said wipes is pulled through said orifice using a dispensing force that is greater than said activation force thereby causing said portion to increase in thickness from about 20% to about 200%.

2. The apparatus for dispensing wipes according to claim 1, each of said wipes comprising a first region and at least one discrete integral second region, wherein said second region comprises one or more elements protruding out of the x,y plane of said wipes.

3. The apparatus for dispensing wipes according to claim 2, said protruding elements comprising at least one of ridges, tufts, loops and combinations thereof.

4. The apparatus for dispensing wipes according to claim 1, wherein said wipes are stacked in said dispenser in an interleaved configuration.

5. The apparatus for dispensing wipes according to claim 1, wherein said wipes:
a. comprise a continuous strip of material with perforations between each wipe; and
b. are present in said dispenser in the configuration of a stack or a roll into which said wipes are wound.

6. The apparatus for dispensing wipes according to claim 1, wherein said wipes are pre-moistened with a liquid composition.

7. The apparatus for dispensing wipes according to claim 1, wherein said wipes have a color and at least a portion of said dispenser proximate to said orifice has a color that contrasts with said color of said wipes.

8. An apparatus for dispensing wipes comprising:
a. a dispenser having an interior storage space for storing a plurality of wipes and an orifice for providing access to wipes stored in the interior storage space; and
b. a plurality of wipes disposed in the interior storage space of said dispenser, each wipe having:
i. an x,y plane;
ii. an MD and a CD direction;
iii. an activation force;
iv. a plurality of first regions; and
v. a plurality of second regions protruding out of said x,y plane of each wipe;
wherein when at least one of said wipes is removed from the interior storage space, at least a portion of said wipe is pulled in the CD direction through said orifice using a dispensing force that is greater than said activation force thereby causing said second regions of said portion to displace such that one or more of said second regions protrude out of a first side of the x,y plane of said wipe, and one or more of said second regions protrude out of an opposing second side of the x,y plane of said wipe.

9. The apparatus for dispensing wipes according to claim 8, wherein said second regions protruding out of said first side of said x,y plane protrude at least about 3 mm and said second regions protruding out of said second side of said x,y plane protrude at least about 3 mm during dispensing.

10. The apparatus for dispensing wipes according to claim 8, wherein said second regions comprise ridges, tufts, loops and combinations thereof.

11. The apparatus for dispensing wipes according to claim 8, wherein said wipes are stacked in said dispenser in an interleaved configuration.

12. The apparatus for dispensing wipes according to claim 8, wherein said wipes:
a. comprise a continuous strip of material with perforations between each wipe; and
b. are present in said dispenser in the configuration of a stack or a roll into which said wipes are wound.

13. The apparatus for dispensing wipes according to claim 8, wherein said wipes are pre-moistened with a liquid composition.

14. The apparatus for dispensing wipes according to claim 8, wherein said wipes have a color and at least a portion of said dispenser proximate to said orifice has a color that contrasts with said color of said wipes.

15. The apparatus for dispensing wipes according to claim 14, said dispenser further comprising indicium which signals to the consumer that wipes stored therein increase in thickness during dispensing.

16. A method for visually signaling the thickness of a wet wipe during dispensing comprising the steps of:
(a) providing a dispenser having an interior storage space and an orifice for accessing wipes stored in the interior storage space;
(b) storing a plurality of folded wipes moistened with liquid composition in said interior storage space of said dispenser in a stacked, interleaved configuration, each wipe having:
i. an x,y plane;
ii. a color;
iii. an MD and a CD direction;
iv. an activation force;
v. a plurality of first regions; and
vi. a plurality of second regions protruding out of a first side of said x,y plane of each wipe;
(c) configuring the dispenser such that when at least a portion of one of said wipes is dispensed through the orifice, at least a portion of the wipe is pulled in the CD direction through said orifice by a dispensing force that is greater than said activation force thereby causing a portion of said second regions to displace such that they protrude out of a second side of said x,y plane of said wipe.

17. The method of claim 16, wherein said second regions protruding out of said x,y plane of each wipe have an average height of at least about 3 millimeters.

18. The method of claim 17, wherein said protruding elements comprise ridges, tufts, loops and combinations thereof.

19. The method of claim 16, further comprising the step of providing an area of said dispenser proximate to said orifice with a color that contrasts with said color of said wipes, such that said area is a background against which to view said wipes during dispensing.

20. The method of claim 17, further comprising the step of providing an indicium on said dispenser which signals to a consumer that said wipes increase in thickness during dispensing.
